(19) United States
(12) Patent Application Publication
(10) Pub. No.: US 2021/0337507 A1
(43) Pub. Date: Oct. 28, 2021

(54) METHODS, APPARATUSES, AND COMPUTER SOFTWARE PRODUCTS FOR PAGING

(71) Applicant: Nokia Technologies Oy, Espoo (FI)

(72) Inventors: Srinivasan SELVAGANAPATHY, Bangalore (IN); Jussi-Pekka KOSKINEN, Oulu (FI); Haitao LI, Beijing (CN); Rapeepat RATASUK, Inverness, IL (US); Nitin MANGALVEDHE, Hoffman Estates, IL (US)

(21) Appl. No.: 17/278,136

(22) PCT Filed: Sep. 27, 2018
(86) PCT No.: PCT/CN2018/108046

§ 371 Date: Mar. 19, 2021

(51) Int. Cl. H04W 68/02; H04W 76/28

(52) U.S. Cl. CPC H04W 68/02; H04W 76/28

(57) ABSTRACT

Methods, apparatuses, and computer software products for paging, the method comprises: dividing paging occasions within at least one discontinuous reception cycles or within a paging time window of an extended discontinuous reception cycle into multiple paging occasion subgroups based on user equipment characteristics, and broadcasting the multiple paging occasion subgroups in system information (S101); receiving a paging message from a network element, identifying a paging occasion subgroup corresponding to a user equipment to be paged from the multiple paging occasion subgroups and selecting a paging occasion corresponding to the user equipment from the paging occasion subgroup according to the paging message (S103); transmitting a group based wake up signal associated with the paging occasion prior to the paging occasion if the user equipment currently uses group based wake up signal (S104).

### TECHNICAL FIELD

Various example embodiments relate generally to the technology of wireless communication and, more specifically, relates to paging in wireless communication.

### BACKGROUND

In 3GPP release 15, the WUS support is introduced. When ENB and UE supports WUS, the ENB transmits WUS prior to the associated PO if there is valid paging message scheduled for the PO, the UE checks the presence of WUS before trying to decode the NPDCCH or MPDCCH on the associated PO. The UE will attempt to decode the NPDCCH or MPDCCH on the PO only if the UE receives WUS, and if the UE detects nothing, then it will go back to sleep, in other words, the UE will not attempt to monitor or decode NPDCCH or MPDCCH on the PO if there is no paging scheduled for the PO.

New work items for further enhancements for NB-IoT and eMTC is approved for 3GPP release 16, one of the objectives of the work item is the introduction of GWUS to further improve the energy efficiency related to idle mode downlink reception. The purpose of introducing GWUS is to reduce the false wake up of all the UEs associated to the PO. The prior art does not provide any implementation of paging with GWUS.

### BRIEF SUMMARY

This section is intended to include examples and is not intended to be limiting.

According to one example embodiment, a method for paging, comprises: dividing paging occasions (POs) within at least one discontinuous reception cycles (DRXs) or within a paging time window (PTW) of an extended discontinuous reception cycle (eDRX) into multiple paging occasion subgroups (PO subgroups) based on user equipment characteristics, and broadcasting the multiple paging occasion subgroups in system information (SI); receiving a paging message from a network element, identifying a paging occasion (PO) subgroup corresponding to a user equipment to be paged from the multiple paging occasion subgroups and selecting a paging occasion corresponding to the user equipment from the paging occasion subgroup according to the paging message; transmitting a group based wake up signal (GWUS) associated with the paging occasion prior to the paging occasion if the user equipment currently uses group based wake up signal.

According to one example embodiment, a method for paging, comprises: receiving system information comprising multiple paging occasion subgroups within at least one discontinuous reception cycles or within a paging time window of an extended discontinuous reception cycle; identifying a paging occasion subgroup corresponding to a user equipment from the multiple paging occasion subgroups, and selecting a paging occasion corresponding to the user equipment from the paging occasion subgroup when the user equipment wakes up in its discontinuous reception cycle or on its paging time window; receiving a group based wake up signal associated with the paging occasion; checking the group based wake up signal before trying to decode the downlink control channel on the paging occasion.

According to another example embodiment, a first apparatus for paging, comprises: at least one processor; and at least one memory including computer program code, the at least one memory and the computer program code configured to, with the at least one processor, cause the first apparatus to perform operation of at least the following: dividing paging occasions within at least one discontinuous reception cycles or within a paging time window of an extended discontinuous reception cycle into multiple paging occasion subgroups based on user equipment characteristics, and broadcasting the multiple paging occasion subgroups in system information; receiving a paging message from a network element, identifying a paging occasion subgroup corresponding to a user equipment to be paged from the multiple paging occasion subgroups and selecting a paging occasion corresponding to the user equipment from the paging occasion subgroup according to the paging message; transmitting a group based wake up signal associated with the paging occasion prior to the paging occasion if the user equipment currently uses group based wake up signal.

According to another example embodiment, a second apparatus for paging, comprises: at least one processor; and at least one memory including computer program code, the at least one memory and the computer program code configured to, with the at least one processor, cause the second apparatus to perform operation of at least the following: receiving system information comprising multiple paging occasion subgroups within at least one discontinuous reception cycles or within a paging time window of an extended discontinuous reception cycle; identifying a paging occasion subgroup corresponding to a user equipment from the multiple paging occasion subgroups, and selecting a paging occasion corresponding to the user equipment from the paging occasion subgroup when the user equipment wakes up in its discontinuous reception cycle or on its paging time window; receiving a group based wake up signal associated with the paging occasion; checking the group based wake up signal before trying to decode the downlink control channel on the paging occasion.

According to another example embodiment, a computer program product comprising a non-transitory computer-readable medium storing computer program code thereon which when executed by a device causes the device to perform at least: dividing paging occasions within at least one discontinuous reception cycles or within a paging time window of an extended discontinuous reception cycle into multiple paging occasion subgroups based on user equipment characteristics, and broadcasting the multiple paging occasion subgroups in system information; receiving a paging message from a network element, identifying a paging occasion subgroup corresponding to a user equipment to be paged from the multiple paging occasion subgroups and selecting a paging occasion corresponding to the user equipment from the paging occasion subgroup according to the paging message; transmitting a group based wake up signal associated with the paging occasion prior to the paging occasion if the user equipment currently uses group based wake up signal.

According to another example embodiment, a computer program product comprising a non-transitory computer-readable medium storing computer program code thereon which when executed by a device causes the device to perform at least: receiving system information comprising multiple paging occasion subgroups within at least one discontinuous reception cycles or within a paging time window of an extended discontinuous reception cycle; identifying a paging occasion subgroup corresponding to a user equipment from the multiple paging occasion subgroups, and selecting a paging occasion corresponding to the user equipment from the paging occasion subgroup when the user equipment wakes up in its discontinuous reception cycle or on its paging time window; receiving a group based wake up signal associated with the paging occasion; checking the group based wake up signal before trying to decode the downlink control channel on the paging occasion.

### BRIEF DESCRIPTION OF THE DRAWINGS

For proper understanding of the example embodiments, reference should be made to the accompanying drawings, wherein:

FIG. 1 shows an exemplary flow chart for paging according to an embodiment.

FIG. 2 shows an exemplary schematic of PO subgroups within a DRX cycle according to an embodiment.

FIG. 3 shows another exemplary schematic of PO subgroups within a DRX cycle according to an embodiment.

FIG. 4 shows an exemplary system for paging in NB-IoT according to an embodiment.

### DETAILED DESCRIPTION

The word “exemplary” is used herein to mean “serving as an example, instance, or illustration.”

Any embodiment described herein as “exemplary” is not necessarily to be construed as preferred or advantageous over other embodiments. All of the embodiments described in this Detailed Description are exemplary embodiments provided to enable persons skilled in the art to make or use the disclosure and not to limit the scope of the disclosure.

In some example embodiment, the method according to this disclosure is implemented by a first apparatus; in some example embodiments, the method according to this disclosure is implemented by a first apparatus and a second apparatus.

Herein, the first apparatus could be an ENB supporting GWUS, or could be a component or device that is able to implement all the steps of the according method, which could be included in an ENB or other equipment with equivalent or similar functions. The second apparatus could be a UE, or could be a component or device that is able to implement all the steps of the according method, which could be included in a UE or other equipment with equivalent or similar functions.

The exemplary embodiments herein describe techniques for paging with GWUS in NB-IoT. Wherein, ENB broadcasts whether GWUS is used in the cell along with the GWUS common configuration in system information.

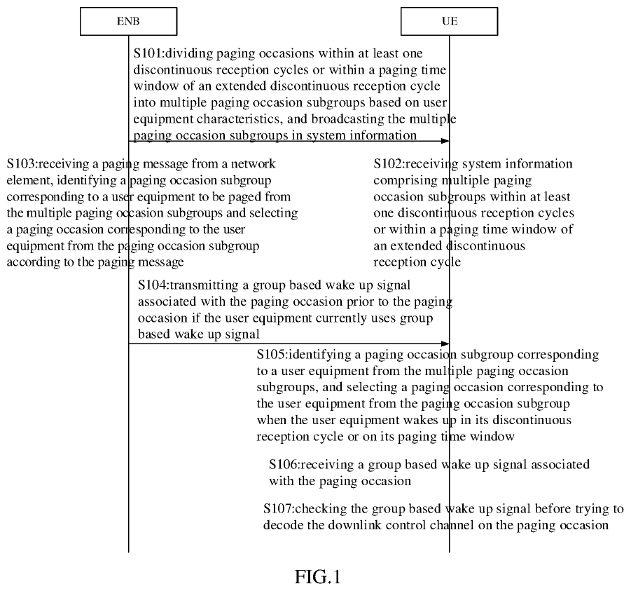

FIG. 1 shows an exemplary flow chart of a method for paging according to an embodiment.

The method according to an exemplary including steps S101, S103, S104 implemented by an ENB, and steps S102, S105, S106, S107 implemented by a UE.

In step S101, the ENB divides paging occasions within at least one discontinuous reception cycles or within a paging time window of an extended discontinuous reception cycle into multiple paging occasion subgroups based on user equipment characteristics, and broadcasting the multiple paging occasion subgroups in system information.

Paging profile type is not UE capability. It is UE profile for some specific type. Generic term could be UE characteristics (in terms of mobility, DRX cycle, paging frequency) or capability (WUS capable or GWUS capable).

The user equipment characteristics herein may be any characteristic related to the user equipment. Preferably, the parameter information includes, but not limited to, parameter related to UE capabilities (such as WUS capable or GWUS capable), an offset for GWUS, number of PO per DRX cycle, paging profile index (which indicates UE profile for some specific type).

In one embodiment, there are some GWUS capable UEs and some WUS capable UEs in the system (such as NB-IoT or eMTC system), the parameter information includes an offset for GWUS, the ENB assigns different Paging configuration for GWUS capable UE from WUS capable UE based on the offset for GWUS, then, the ENB determines a PO subgroup for GWUS within the at least one DRX cycles according to Paging configuration for GWUS capable UE, and determines another PO subgroup for WUS within the at least one DRX cycles according to Paging configuration for WUS. It can effectively improve paging reception performance and reduce false wakeup.

Wherein, GWUS capable UE means UE supports GWUS and also configured by the network to monitor GWUS (as GWUS UE can be configured to monitor GWUS, WUS, or NPDCCH). Note that GWUS capable UEs are also capable of WUS, and may be configured by the network to monitor either GWUS or WUS or both.

Similarly, WUS capable UE means UE supports WUS and also configured by the network to monitor WUS.

Alternatively, the PO subgroup for GWUS are reserved for transmission of paging messages only for GWUS capable UE.

Alternatively, priority paging GWUS capable UE on these POs in the PO subgroup for GWUS. If at least one GWUS capable UE is paged in one of these POs, a WUS capable UE will not be paged in the same PO. If there is no paging to be sent for GWUS capable UE, however, paging message for WUS capable UE can be scheduled. On these POs, paging message to GWUS capable UE and WUS capable UE can be multiplexed to improve the paging efficiency. In this embodiment, GWUS capable UEs monitor only the GWUS transmissions associated with these reserved POs. TDM of WUS and GWUS is not required for these POs, so the maximum GWUS duration broadcasted in system information can overlap with the configured maximum WUS duration, for example, the GWUS maximum duration configuration is identical to the WUS maximum duration configuration.

Alternately, subset of DRX cycles can be reserved for transmission of paging messages for GWUS capable UE.

Alternately, the PO subgroup for GWUS can be configured over a period spanning multiple DRX cycles, within this configuration period, POs in the PO subgroup for GWUS can be continuous, indicated with a starting PO and a subgroup length. Alternatively, PO subgroup can be indicated with a bitmap, a bitmap can also be used to indicate the subset of DRX cycles with reserved POs.

Alternatively, the offset for GWUS may be relative to the PO or PF, for example, the offset is 1 ms when relative to PO, and 10 ms when relative to PF. Preferably, the offset for GWUS is based on an offset for WUS and a delta, it can help minimize potential false alarm by WUS UEs.

Wherein, ENB assigns new Paging configuration for GWUS capable UE in system information, for example, new system information contents at high level is provided as following:

| | |
|---|---|
| PCCH-Config-NB-GWUS::= | SEQUENCE { |
| nB-GWUS | ENUMERATED { |
| | fourT, twoT, oneT, halfT, quarterT, |
| | one8thT,one16thT, one32ndT, one64thT, |
| | one128thT, one256thT, one512thT, |
| | one1024thT, spare3, spare2, spare1}, |

| | |
|---|---|
| npdcch-NumRepetitionPaging-r13 | ENUMERATED { |
| | r1, r2, r4, r8, r16, r32, r64, r128, |
| | r256, r512, r1024, r2048, |
| | spare4, spare3, spare2, spare1} |
| PO-offset | Integer |

}

Wherein, parameter nB-GWUS is used to calculate the PF for GWUS. PF is given by following equation:

SFN mod T=(T div N)*(UE_ID mod N);

where SFN is System Frame Number, T is the DRX cycle of UE, N=min (T,nB−GWUS), UE_ID is ID of UE.

Wherein, parameter PO-offset is the offset value of GWUS-PO compared to the legacy PO calculation, for example, if subframes {0, 4, 5, 9} are legacy candidate POs, then candidate GWUS-POs would be {PO-offset, 4+PO-offset, 5+PO-offset, 9+PO-offset}. Legacy PO is calculated as index i_s pointing to PO from subframe pattern defined in 7.2 of TS36.304:

i_s=floor (UE_ID/N) mod Ns;

where Ns=max (1, nB-GWUS/T).

Wherein, parameter npdcch-NumRepetitionPaging-r13 represents the maximum number of repetitions for NPDCCH common search space (CSS) for receiving GWUS-based paging.

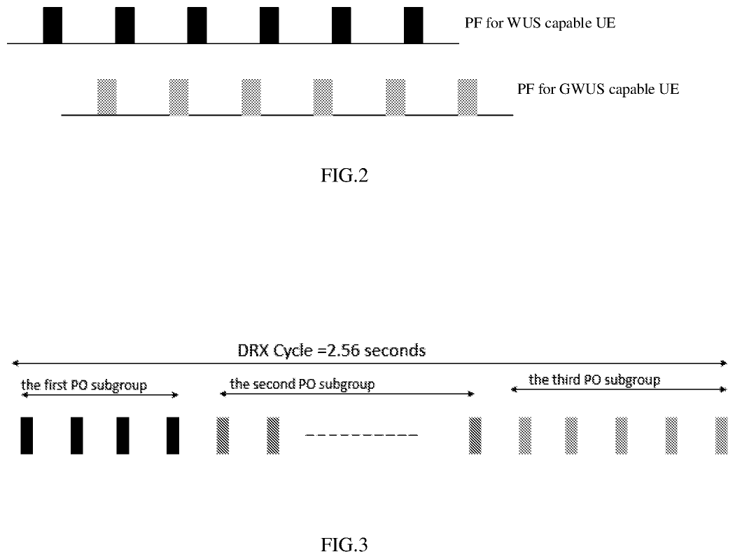

As an further example, the PO assignment with the above new system information is illustrated in FIG. 2, the upper line is PF for WUS capable UE (every even SFN), and the lower line is PF for GWUS capable UE with some offset in assignment formula, the ENB treats all POs in the lower line as a PO subgroup for GWUS capable UE, and treats all POs in the upper line as a PO subgroup for WUS capable UE.

In another embodiment, the ENB dividing POs for GWUS within the at least one DRX cycles into multiple PO subgroups based on the paging profile index, wherein each PO subgroup corresponding to different value of the paging profile index.

Wherein, POs for GWUS may be all or part of the POs within the at least one DRX cycles. As an example, there are some GWUS capable UEs and some WUS capable UEs in NB-IoT, POs for GWUS in this embodiment may be all POs in the PO subgroup for GWUS. As another example, all the UE in the system supports GWUS capability, all POs can be assigned for GWUS capable UEs, so POs for GWUS in this embodiment may be all POs within DRX cycle.

The paging profile index indicates index of paging profile, preferably, the paging profile index includes, but not limited to, EDRX-Profile-Index, Paging-frequency-Profile-Index, Mobility-Profile-index (MPI). Wherein value of a paging profile index maps to one range of value associated with the paging profile. For example, Mobility-Profile of UEs is divided into two types: stationary, mobility; “MPI=0” indicates that mobility profile is Stationary, “MPI=1” indicates that mobility profile is mobility.

Each UE is assigned with paging-profile-index for PO subgrouping. MME can assign this value based on one or more of the following criteria: device type, mobility profile, subscription type, service type, and coverage level.

For each paging profile index, the ENB configures PO subgroups of POs within the PO list within DRX cycle (s). The PO subgroups can be either explicitly indicated or implicitly determined (e.g., based on paging profile index). For example, EDRX-Profile-Index corresponds to three values “short-eDRX/med-eDRX/long-eDRX”, the ENB dividing POs within DRX cycle (2.56 seconds) into three PO subgroups mapped to each value of EDRX-Profile-Index, as shown in FIG. 3, wherein, number of Pos within the DRX cycle is 256 (One PO per radio frame), the first subgroup mapped to short-eDRX, the second subgroup mapped to med-eDRX, and the third subgroup mapped to long-eDRX.

It should be noted, for each paging profile index, the corresponding PO subgroups can be mutually exclusive, but a PO may be included in two PO subgroups corresponding to different paging-profile-indexes. ENB decides to use some part of paging profile index for PO subgroup assignment. As an example, ENB decides use EDRX-Profile-Index for PO subgroup assignment. As another example, ENB decides use EDRX-Profile-Index and Paging-frequency-Profile-Index for PO subgroup assignment.

It should be noted that a PO subgroup can be further divided into multiple subgroups via GWUS sequence differentiation.

In step S102, UE receives system information comprising multiple paging occasion subgroups within at least one discontinuous reception cycles or within a paging time window of an extended discontinuous reception cycle.

In step S103, ENB receives a paging message a network element, identifies a paging occasion subgroup corresponding to a user equipment to be paged from the multiple paging occasion subgroups and selects a paging occasion corresponding to the user equipment from the paging occasion subgroup according to the paging message.

The network element may be any element that sends a paging message to the base station, such as MME.

In one exemplary embodiment, in step S101, the ENB obtains two PO subgroups based on an offset for GWUS, one for GWUS and another for WUS, in step S103, the ENB receives a paging message from MME, then identifies the PO subgroup for GWUS from the two PO subgroups when the UE to be paged is enabled for GWUS, and selects a PO corresponding to the UE from the PO subgroup for GWUS based on ID of the UE.

In another exemplary embodiment, in step S101, the ENB obtains three PO subgroups based on EDRX-Profile-Index, in step S103, the ENB receives a paging message from MME, the paging message comprise another paging profile index (such as MPI) for assigning PO subgroup to UE, then the ENB identifies a PO subgroup from the three PO subgroups according to said another paging profile index, and selects a PO from the PO subgroup based on ID of the UE.

In step S104, the ENB transmits a group based wake up signal associated with the paging occasion prior to the paging occasion if the user equipment currently uses group based wake up signal.

The user equipment currently uses group based wake up signal means that UE supports GWUS and also configured by the network to monitor GWUS.

In one exemplary embodiment, the ENB obtains two PO subgroups based on an offset for GWUS, one for GWUS and another for WUS, in step S104, the ENB transmits GWUS associated with the PO prior to the PO if the UE currently uses GWUS, GWUS associated with the PO carries UE subgroup information.

GWUS carries the information indicating which UE subgroup needs to monitor the following PO(s).

In another exemplary embodiment, the ENB obtains multiple PO subgroups based on paging profile index, in step S104, the ENB transmits GWUS associated with the PO prior to the PO if the UE supports GWUS, GWUS associated with the PO carries another paging profile index and UE subgroup information. For example, GWUS contain 4 bits of information: 1 bit indicates mobility profile and 3 bits indicate UE-subgroup-ID based on IMSI.

Wherein, the system information indicates the criteria on which the UE subgroup information is based, in other words, whether the subgroup information of GWUS is based on UE_ID or some other criteria such as DRX/eDRX cycle configuration is configured via additional system information.

A unique GWUS identifies each UE subgroup, GWUSs associated with the different UE subgroups can be multiplexed (e.g., FDM, TDM, or CDM) when UEs to be paged belong to multiple UE subgroups within the same PO. The same GWUSs can be reused within each PO subgroup since the different PO subgroups are non-overlapping.

Preferably, as the statistics of paging distribution, ENB can switch the interpretation of GWUS from one type to another type. The ENB configures which paging profile index will be carried in GWUS, the interpretation of GWUS can be modified by ENB via system information.

It should be noted that, when the UE to be paged does not support GWUS, the ENB will not perform step S104. For example, when the UE to be paged is enabled for WUS, the ENB transmits WUS associated with the PO prior to the PO.

In step S105, the UE identifies a paging occasion subgroup corresponding to a user equipment from the multiple paging occasion subgroups, and selects a paging occasion corresponding to the user equipment from the paging occasion subgroup when the user equipment wakes up in its discontinuous reception cycle or on its paging time window.

In one exemplary embodiment, the ENB obtains two PO subgroups based on an offset for GWUS, so the system information indicates the two PO subgroups within the at least one DRX cycles, one for GWUS and another for WUS. In step S105, when the UE wakes up on its PTW, if the UE is enabled for GWUS, the UE identifies the PO subgroup for GWUS from the two PO subgroups, and selects a PO from the PO subgroup for GWUS based on ID of the UE. If the UE is enabled for WUS, the UE identifies the PO subgroup for WUS from the two PO subgroups, and selects a PO from the PO subgroup for WUS based on ID of the UE.

In another exemplary embodiment, the ENB obtains multiple PO subgroups based on paging profile index. In step S105, when the UE wakes up on its PTW, the UE identifies a PO subgroup from the multiple PO subgroups based on paging profile index of the UE, and selects a PO from the PO subgroup based on ID of the UE. Wherein, the UE knows its paging profile index as part of its registration, and within the PO subgroup, the UE selects PO based PO assignment formula used for legacy system. As an example, the ENB obtains three PO subgroups based on EDRX-Profile-Index shown in FIG. 3, In step S105, when the UE wakes up on its PTW (in case of DRX, every DRX cycle), the UE identifies the first PO subgroup based on its DRX cycle length (short-eDRX), and selects a PO from the first PO subgroup based on ID of the UE.

In the step S106, the UE receives a group based wake up signal associated with the paging occasion.

It should be noted that, FIG. 1 only shows the receiving operation of a GWUS capable UE, and those skilled in the art should understand that, if a UE does not support GWUS, the UE will perform the receiving operation according to the legacy system.

In the step S107, the UE checks the group based wake up signal before trying to decode the downlink control channel on the paging occasion.

As an example, EDRX-Profile of a UE is “short-eDRX”, Mobility-Profile of the UE is “mobility”, and IMSI of the UE is 9. In the step S101, the ENB dividing POs within DRX cycle into three PO subgroups shown in FIG. 3. In the step S103, the ENB receives a paging message from MME, ENB selects the first PO subgroup in FIG. 3 corresponds to short-eDRX cycle, and selects a PO from the first PO subgroup based on IMSI of the UE to be paged. In step S104, the ENB transmits GWUS prior to the selected PO, wherein GWUS contains 4 bits, the first bit set to mobility, and remaining 3 bits set to IMSI-mod-3=0. In the step S105, when the UE wakes up on its PTW, the UE identifies the first PO subgroup according to its EDRX-Profile, and selects a PO from the first PO subgroup based on IMSI of the UE. In the step S107, before trying to decode the downlink control channel on the PO, the UE checks for GWUS on its PO, and the UE checks if GWUS corresponds to value 1000. It should be noted that, if GWUS does not present, UE will not wake up. This makes that stationary UE with long eDRX need not wake-up when paging is sent for short-eDRX UE with high mobility.

We found that when the PO assignment for idle mode UE is only based on UE_ID, it is possible that both GWUS capable UE and WUS capable UE are assigned to the same PO in ENB supporting GWUS functionality. In such scenarios, the ENB may need to allocate WUS Window for transmission of both GWUS and WUS in TDM manner successive to each other to allow sending paging for WUS capable UE and GWUS capable UE through single paging message. Alternatively, ENB may send GWUS only if the paging needs to be sent for GWUS capable UE only and use WUS if the paging message contains at least one UE does not support GWUS. For this option, the UE may need to blindly try to decode both WUS and GWUS prior to PO. This may increase the device complexity and also lead to increased false wakeup for GWUS capable UE even when ENB only schedules page for WUS capable UE. However, both these options have some disadvantages in terms of either resource allocation or energy efficiency.

According to the embodiments of the present disclosure, interworking with WUS and GWUS can be realized by assigning different Paging configuration for GWUS capable UE from WUS capable UE based on the offset for GWUS, and UEs currently using WUS will not be woken up when paging UE (s) currently using GWUS, UEs currently using GWUS will not be woken up when paging UE (s) currently using WUS, thereby improving the efficiency of paging reception and reducing false wakeup.

We also found that when the GWUS is introduced, one simple option to realise the grouping functionality is to include the subgroup identifier as part of GWUS sequence. However, the default option of grouping the UE based on UE_ID is not efficient as the idle mode UE distribution based on UE_ID subgroup may not be even and not efficient in all the scenarios. For example, it is possible that all the UEs in PO may belong to one subgroup itself based on UE_ID-based grouping. This may lead to inefficient wakeup on the specific PO. Other options of UE grouping such as mobility-based grouping, DRX cycle based grouping may be more efficient. In network consisting of different types UE, fixing the grouping mechanism based on single criteria is not a suitable solution.

According to the embodiments of the present disclosure, ENB can divide POs for GWUS within the at least one DRX cycles into multiple PO subgroups based on the paging profile index, thereby achieving the coexistence of multiple grouping mechanisms, it can effectively improve the efficiency of paging reception and reduce false wakeup. For example, a stationary UE which expects infrequent paging is configured with higher eDRX cycle, when this UE wakes up on its PTW, on the PO subgroup for this eDRX cycle length, no UE belongs to other DRX cycles will be mapped, so these UEs belongs to other DRX cycles will not wake up for paging to UEs with higher eDRX cycle. In the same way when more frequent pages or page repetitions are expected for mobility UE, with the help of first bit indicating mobility type, the stationary UE will not detect GWUS and thus will not wakeup when page is sent for high mobility UE, it is applicable when stationary and mobility device is expecting same frequency of network command/delay for network command response, so they are configured with same eDRX cycle and thus share the same PO subgroup.

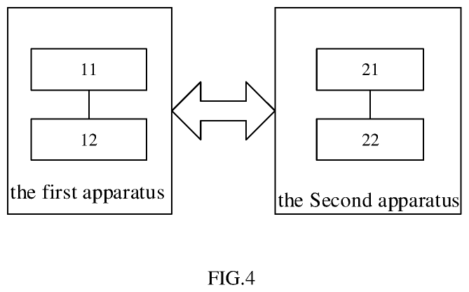

Specifically, FIG. 4 shows a block diagram of a simple system with both a first apparatus and a second apparatus.

Wherein the first apparatus comprises at least one processor 11; and at least one memory 12 including computer program code. The at least one memory 12 and the computer program code configured to, with the at least one processor 11, cause the first apparatus to perform operation of at least the following: dividing POs within at least one DRX cycles into multiple PO subgroups based on parameter information related to UE capability, and broadcasting the multiple PO subgroups in system information; receiving a paging message from MME, identifying a PO subgroup corresponding to a UE to be paged from the multiple PO subgroups and selecting a PO corresponding to the UE from the PO subgroup according to the paging message; transmitting GWUS associated with the PO prior to the PO if the UE supports GWUS.

The second apparatus, comprises at least one processor 21; and at least one memory 22 including computer program code, the at least one memory 22 and the computer program code configured to, with the at least one processor 21, cause the second apparatus to perform operation of at least the following: receiving system information comprising multiple PO subgroups within at least one DRX cycles; identifying a PO subgroup corresponding to a UE from the multiple PO subgroups, and selecting a PO corresponding to the UE from the PO subgroup when the UE wakes up on its PTW; receiving GWUS associated with the PO; checking the GWUS before trying to decode the NPDCCH on the PO.

The operations of the first apparatus and the second apparatus are similar with the steps that have been described above and will not repeated herein.

Also, a computer program product is disclosed. The computer program product comprising a non-transitory computer-readable medium storing computer program code thereon which when executed by a device causes the device to perform at least: dividing POs within at least one DRX cycles into multiple PO subgroups based on parameter information related to UE capability, and broadcasting the multiple PO subgroups in system information; receiving a paging message from MME, identifying a PO subgroup corresponding to a UE to be paged from the multiple PO subgroups and selecting a PO corresponding to the UE from the PO subgroup according to the paging message; transmitting GWUS associated with the PO prior to the PO if the UE supports GWU.

And a computer program product comprising a non-transitory computer-readable medium storing computer program code thereon which when executed by a device causes the device to perform at least: receiving system information comprising multiple PO subgroups within at least one DRX cycles; identifying a PO subgroup corresponding to a UE from the multiple PO subgroups, and selecting a PO corresponding to the UE from the PO subgroup when the UE wakes up on its PTW; receiving GWUS associated with the PO; checking the GWUS before trying to decode the NPDCCH on the PO.

For a person skilled in the art, it is apparent that the present disclosure is not limited to the details of the above exemplary embodiments, and the present disclosure can be implemented in other specific forms without departing from the spirit or essential characteristics of the present disclosure. Therefore, the embodiments should be regarded as exemplarily and not restrictive, and the scope of the present disclosure is defined by the appended claims rather than the above description, and therefore it is intended that the claims All changes that come within the meaning and range of equivalency of the disclosure are encompassed by the disclosure. Any reference signs in the claims should not be regarded as limiting the involved claims. In addition, it is clear that the word “comprising” does not exclude other units or steps, and the singular does not exclude the plural. The multiple units or devices recited in the system claims may also be implemented by one unit or device through software or hardware. Words such as first, second, etc., are used to indicate a name and do not indicate any specific order.

The following abbreviations that may be found in the specification and/or the drawing figures are defined as follows:
NB-IoT Narrow Band Internet of Things
3GPP 3rd Generation Partnership Project
eMTC Enhanced Machine Type Communications
ENB Evolved Node B
UE User Equipment
WUS Wake Up Signal
PO Paging Occasion
PF Paging Frame
DRX Discontinuous Reception
eDRX extended Discontinuous Reception
MPDCCH MTC physical downlink control channel
NPDCCH Narrowband physical downlink control channel
GWUS Group based Wake Up Signal
PTW Paging Time Window
MME Mobility Management Entity

1.-6. (canceled)

7. A method for paging, comprises:
receiving system information indicating multiple paging occasion subgroups within at least one discontinuous reception cycles or within a paging time window of an extended discontinuous reception cycle;
identifying a paging occasion subgroup corresponding to a user equipment from the multiple paging occasion subgroups, and selecting a paging occasion corresponding to the user equipment from the paging occasion subgroup when the user equipment wakes up in its discontinuous reception cycle or on its paging time window;
receiving a group based wake up signal associated with the paging occasion;
checking the group based wake up signal before trying to decode a downlink control channel on the paging occasion.

8. The method of claim 7, wherein the system information indicates two paging occasion subgroups within the at least one discontinuous reception cycle or within the paging time window of the extended discontinuous reception cycle, one for the group based wake up signal and another for a wake up signal, wherein the step of identifying further comprises:
identifying the paging occasion subgroup for the group based wake up signal from the two paging occasion subgroups, and selecting the paging occasion corresponding to the user equipment from the paging occasion subgroup for the group based wake up signal based on an identity of the user equipment when the user equipment wakes up in its discontinuous reception cycle or on its paging time window.

9. The method of claim 7, wherein the step of identifying further comprises:
identifying a paging occasion subgroup corresponds to a user equipment from the multiple paging occasion subgroups based on paging profile index of the user equipment, and selecting a paging occasion from the paging occasion subgroup based on an identity of the user equipment when the user equipment wakes up in its discontinuous reception cycle or on its paging time window.

10. An apparatus for paging, comprises:
at least one processor; and
at least one memory including computer program code,
the at least one memory and the computer program code configured to, with the at least one processor, cause the first apparatus to perform operation of at least the following:
dividing paging occasions within at least one discontinuous reception cycles or within a paging time window of an extended discontinuous reception cycle into multiple paging occasion subgroups based on user equipment characteristics, and broadcasting the multiple paging occasion subgroups in system information;
receiving a paging message from a network element, identifying a paging occasion subgroup corresponding to a user equipment to be paged from the multiple paging occasion subgroups and selecting a paging occasion corresponding to the user equipment from the paging occasion subgroup according to the paging message;
transmitting a group based wake up signal associated with the paging occasion prior to the paging occasion.

11. The apparatus of claim 10, wherein the operation of dividing further comprises:
assigning different paging configuration for the group based wake up signal compared to the paging configuration of a wake up signal based on an offset for the group based wake up signal;
determining the paging occasion subgroup for the group based wake up signal within the at least one discontinuous reception cycles or within the paging time window of the extended discontinuous reception cycle according to the paging configuration for the group based wake up signal, and determining another paging occasion subgroup for the wake up signal within the at least one discontinuous reception cycle or within the paging time window of the extended discontinuous reception cycle according to the paging configuration for the wake up signal.

12. The apparatus of claim 10, wherein the operation of dividing further comprises:
dividing paging occasions for the group based wake up signal within the at least one discontinuous reception cycles or within the paging time window of the extended discontinuous reception cycle into multiple paging occasion subgroups based on a paging profile index, wherein each paging occasion subgroup corresponds to a different value of the paging profile index.

13. An apparatus for paging, comprises:
at least one processor; and
at least one memory including computer program code,
the at least one memory and the computer program code configured to, with the at least one processor, cause the second apparatus to perform operation of at least the following:
receiving system information indicating multiple paging occasion subgroups within at least one discontinuous reception cycles or within a paging time window of an extended discontinuous reception cycle;
identifying a paging occasion subgroup corresponding to a user equipment from the multiple paging occasion subgroups, and selecting a paging occasion corresponding to the user equipment from the paging occasion subgroup when the user equipment wakes up in its discontinuous reception cycle or on its paging time window;
receiving a group based wake up signal associated with the paging occasion;
checking the group based wake up signal before trying to decode a downlink control channel on the paging occasion.

14.-15. (canceled)
